(19) United States
(12) Patent Application Publication
(10) Pub. No.: US 2011/0171352 A1
(43) Pub. Date: Jul. 14, 2011

(54) Edible Baking Liner

(76) Inventor: Scott Lange, Homer Glen, IL (US)

(21) Appl. No.: 12/861,054

(22) Filed: Aug. 23, 2010

Related U.S. Application Data
(60) Provisional application No. 61/293,826, filed on Jan. 11, 2010.

(51) Int. Cl. A21D 13/08; A21D 8/02

(52) U.S. Cl. 426/138; 426/502; 426/283

(57) ABSTRACT

An edible baking liner is disclosed which is formed from an edible paper made with large-granule vegetable starch. The liner is baked with the baking product and can be consumed without removing it from the baking product. The edible baking liner can replace the use of an inedible baking liner.

### CROSS-REFERENCE TO RELATED APPLICATIONS

This application claims the benefit of U.S. Provisional Application 61/293,826, filed Jan. 11, 2010, which is hereby incorporated by reference.

### FIELD OF THE INVENTION

This invention generally relates to the use of liners in the preparation of baked goods, and more particularly to an edible liner suitable for accompanying a baked good through the baking process to become an edible part of the baked good.

### BACKGROUND OF THE INVENTION

Certain bakery food products are often prepared with liners, which separate the dough or batter from the material of the baking tin or tray when the container is subjected to heat, such as within an oven, for baking.

A typical liner is a thin, sheet-like material that is either sold in the shape of the baking tin or tray, or is sold in sheets that can be shaped by the baker.

Cupcakes are one example of a confection that is often prepared with a liner. Cupcake liners are sold in a variety of paper-like materials, often in a cup shape of the same size as a conventional cupcake tin. A “batch” of cupcakes can be made by placing cupcake liners in each of the cup-shaped depressions found in a cupcake tin, then filling each liner with cake batter. After baking, each cupcake is easily removed from its depression in the tin with the cupcake liner adhering to the lower part of the confection. The cupcake can be transported intact and held cleanly by the liner. As the cupcake is consumed, the liner is peeled away and discarded.

While conventional cupcake liners are convenient for preparing and transporting cupcakes, they are inconvenient during cupcake consumption. The peeling process requires two hands and can produce crumbs and cupcake fragments. The liner itself usually contains such fragments and must be carefully handled by the fastidious consumer until it can be thrown away, generating waste.

To overcome these problems, edible paper made from rice starch has been suggested as a makeshift cupcake liner. However, rice paper becomes crispy and unappetizing when baked in this way, is vulnerable to moisture, and can very easily break apart, making it an unsatisfying substitute for conventional inedible liners.

A need therefore exists for a liner that does not have to be removed from baked goods prior to consumption, that adequately replaces conventional paper for use in the preparation and transportation of baked goods, and that provides a pleasant texture when consumed as part of a baked good.

### SUMMARY OF THE INVENTION

An edible paper baking liner is disclosed which comprises large-granule vegetable matter of a sort suitable for baking and consuming along with baked goods.

Additionally, a method is disclosed for constructing a liner from edible paper comprising large-granule vegetable matter.

Additionally, a method is disclosed for preparing a baked good that uses an edible paper baking liner as an edible component of the baked good.

### BRIEF DESCRIPTION OF THE DRAWINGS

The accompanying drawings, which are incorporated in and constitute a part of this specification, illustrate embodiments of the invention and, together with the Detailed Description given below, serve to explain the invention.

FIG. 1 is a plan view of a sheet of edible baking paper.

FIG. 2 is a side perspective view of an unfolded baking liner cut from the baking paper of FIG. 1.

FIG. 3 is a side perspective view of the baking liner of FIG. 2, folded.

FIG. 4 is a plan view of a sheet of edible baking paper.

FIG. 5 is a plan view of a sheet of edible baking paper.

FIG. 6 illustrates a side piece of a baking liner being attached to a bottom piece of a baking cup.

FIG. 7 shows the assembled baking liner of FIG. 6.

FIG. 8 is a plan view of a sheet of edible baking paper.

FIG. 9 is a plan view of a sheet of edible baking paper.

FIG. 10 illustrates a side piece of a baking liner being attached to a bottom piece of a baking liner.

FIG. 11 shows the assembled baking liner of FIG. 10.

FIG. 12 illustrates a baking process using an edible liner in accordance with the present invention.

FIG. 13 shows a partially consumed cupcake with an edible liner in accordance with the present invention.

### DETAILED DESCRIPTION

In place of traditional baking liners, in accordance with the principles of the present invention, an edible liner can be used. The liner is constructed of an edible paper material which includes vegetable starch.

In an exemplary embodiment, the vegetable starch may have an average granular size that is greater than about 10 μm. Suitable starches include potato, corn, cassava, sorghum, wheat, tapioca, arrowroot, and sweet potato starches. The vegetable starch may also be included in the edible paper through the use of any flour which contains starch of the appropriate granule size, including varieties of spelt, millet, or white flour.

In one embodiment, the edible paper may be made using a vegetable starch in conjunction with oil and water. For example, the edible liner in accordance with the present invention may be made from potato starch, water, and vegetable oil. The edible paper may be potato-based wafer paper such as is available as cake decoration equipment from bakery supplies stores.

In contrast to wood pulp paper, edible paper is a thin sheet made of food ingredients which can be consumed without harsh effects on the normal human digestive system. Because thin sheets of edible paper are made from food ingredients, edible paper is suitable to be eaten along with baked goods.

Certain varieties of edible paper made with large-granule vegetable starch are used as cake decoration supplements. Typically the paper is applied after the confection is finished baking, and may be part of a cake decoration plan including frosting and other edible and inedible decorations. Food coloring is often included in order to produce a design on the finished baked good.

Edible liners according to the present invention are suitable for receiving and holding unbaked dough or batter, and may be baked along with a baked good. During baking, a liner of the present invention may adhere to the baked good and can be suitable for consuming along with the baked good.

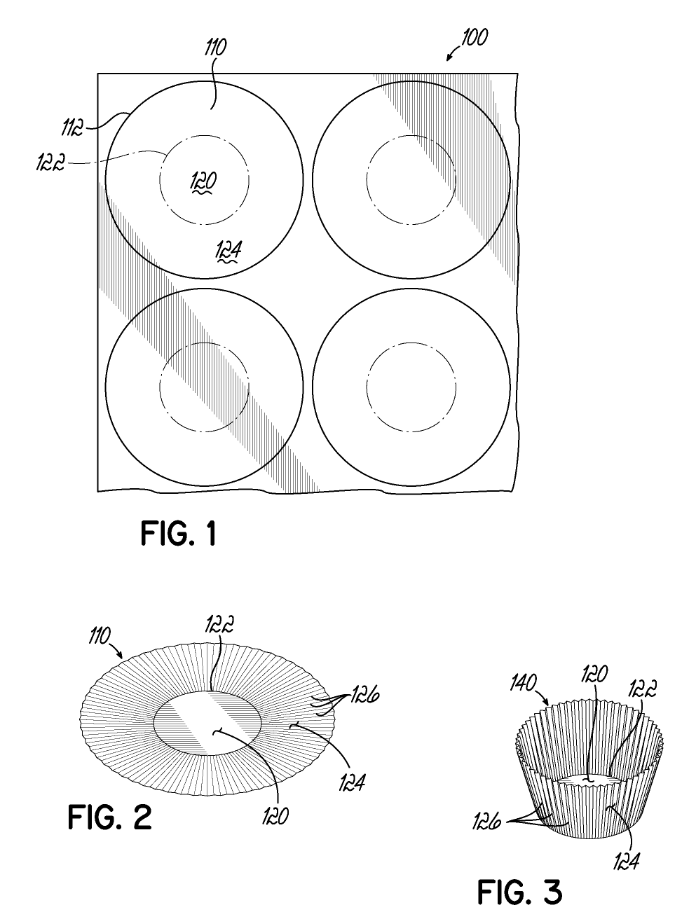

Turning now to the Drawings, wherein similar reference numerals denote similar features throughout the several Figures, as illustrated in FIGS. 1-3, multiple edible liners in accordance with an exemplary embodiment of the present invention may be constructed from a single sheet 100 of edible material as discussed above. A disk 110 is denoted by a solid line 112. The disk 110 may be removed from the sheet 100 by cutting along the solid line 112. On the surface of the disk 110 is a center region 120 which forms the bottom of the liner, and a peripheral region 124 which forms the side surface of the liner. The regions 120 and 124 are demarcated by a dashed boundary line 122. As illustrated in FIG. 3, the peripheral region 124 is folded in a direction generally orthogonal to the center region 120 in such a way as to create pleats 126 along the side surface 124. These pleats 126 may be formed by pressing the disk 110 prior to folding, or may be formed as part of folding the disk 110. The pleats 126 are a consequence of decreasing the outer diameter of the peripheral region 124 when the peripheral region 124 is folded. FIG. 3 illustrates the resulting edible baking liner 140.

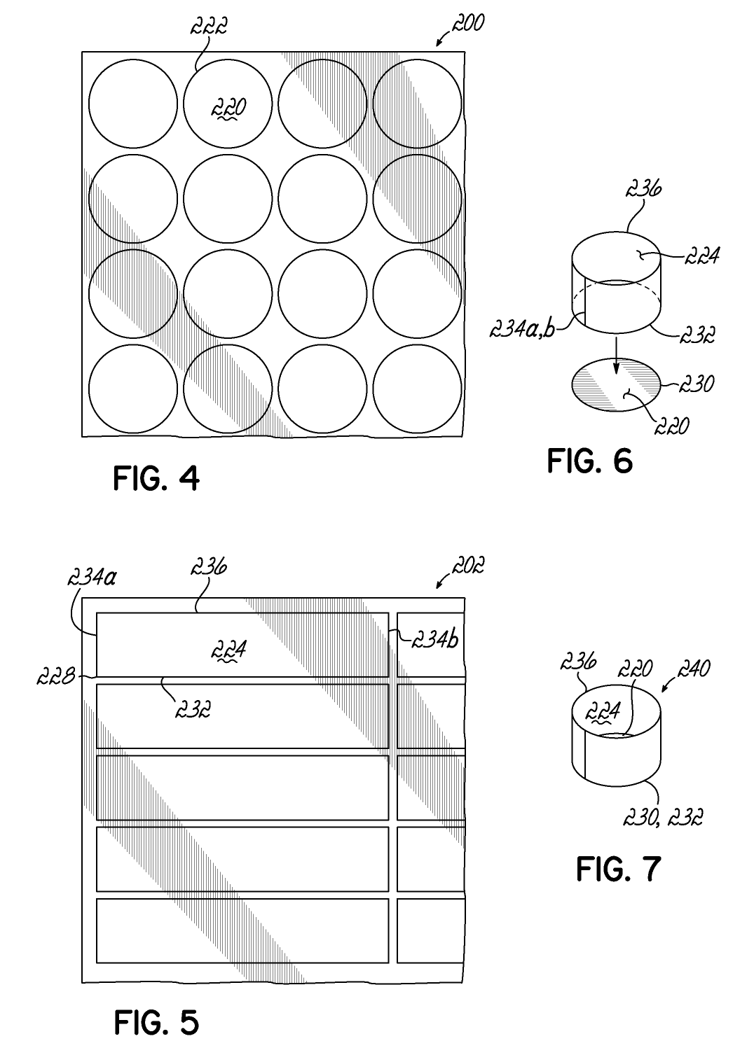

In another exemplary embodiment, an edible baking liner may be constructed from two or more pieces, as shown in FIGS. 4-7. FIG. 4 shows a sheet 200 of edible paper, wherein bottom pieces 220 are cut out along solid boundary lines 222, which results in the disk-shaped bottom pieces 220 having peripheral edges 230 (FIG. 6). FIG. 5 depicts a sheet 202 of edible paper wherein strips are cut out along solid boundary lines 228 to form side pieces 224. Each side piece 224 includes a base edge 232, two side edges 234a and 234b, and a top edge 236, all defined by the cuts made along boundary lines 228. The side piece 224 is assembled into a cylinder shape by attaching the side edges 234a and 234b. One of ordinary skill will understand that it may be appropriate for the side piece 224 to be created longer than the circumference of the bottom piece 220, so that some overlap is allowed to aid in attaching the side edges 234a and 234b together.

The side piece 224 is then attached to the bottom piece 220 at the edges 230 and 232. In one embodiment, water or another liquid may be used at the interface between the edges 230 and 232 in order to aid in attachment. In the embodiment shown, the base edge 232 of the side piece 224 is substantially the same length as the top edge 236, the resulting edible liner 240 has side walls that are substantially perpendicular to the bottom 220, and are not tapered.

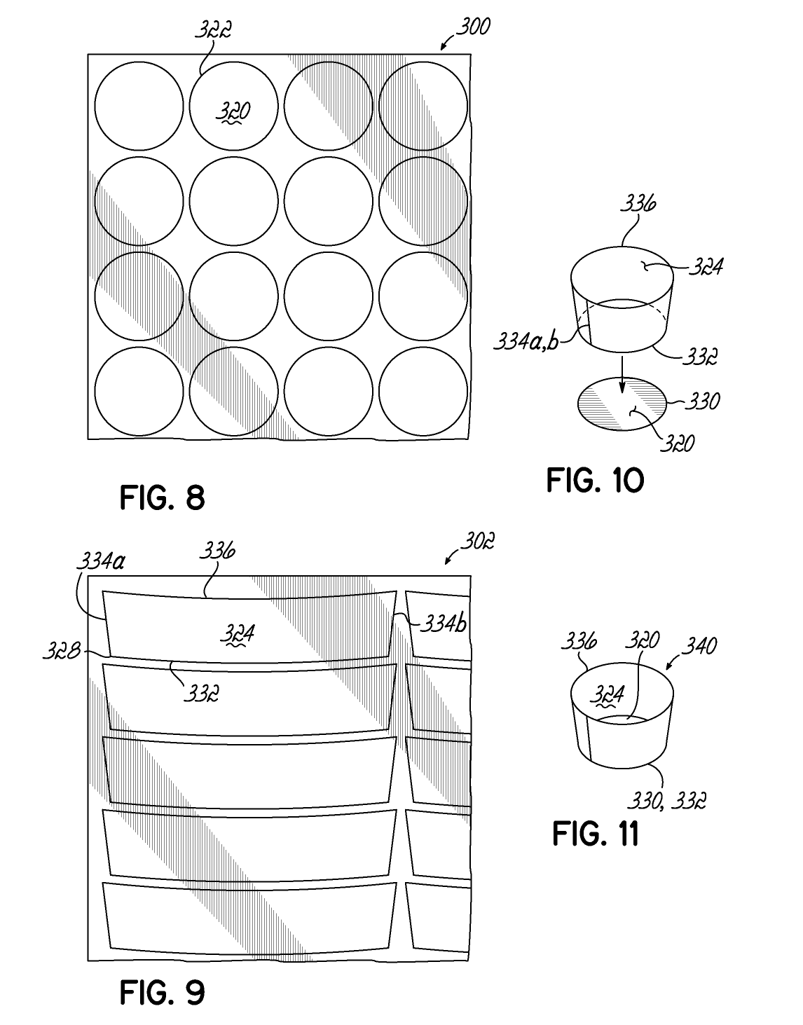

FIGS. 8-11 illustrate another exemplary process of forming edible liners 340, similar to the process described above with respect to FIGS. 4-7, except that the side piece 324 is not rectangular but is instead shaped to allow for a tapered side 324 to the cup-shaped liner 340 when shaped and attached to the bottom piece 320. Other than the change in shape of the side piece 324 and the corresponding change in shape of the resulting cup-shaped liner 340, each of the pieces and steps explained above with respect to FIGS. 4-7 is carried out in a similar manner on the edible sheets 300 and 302; the bottom piece 320 with its peripheral edge 328 formed from cutting along the solid line 322; and the side piece 324 with its bottom edge 332, its side edges 334a and 334b, and its top edge 336 formed by cutting along the solid line 328.

Although FIGS. 1-11 depict a cup-shaped edible container, it will be appreciated that edible containers in accordance with the present invention can alternatively be formed in various other shapes and configurations. Edible liners of other shapes, such as those suitable for baking cakes, loaves, and other baked goods can be made according to the present invention. Nothing here should be construed to confine the edible liner to any particular shape or any particular baked good. A cupcake liner will be used in the discussion of the further example below, but this is, again, merely illustrative and not to be considered limiting of the invention except where specifically included in the claim language.

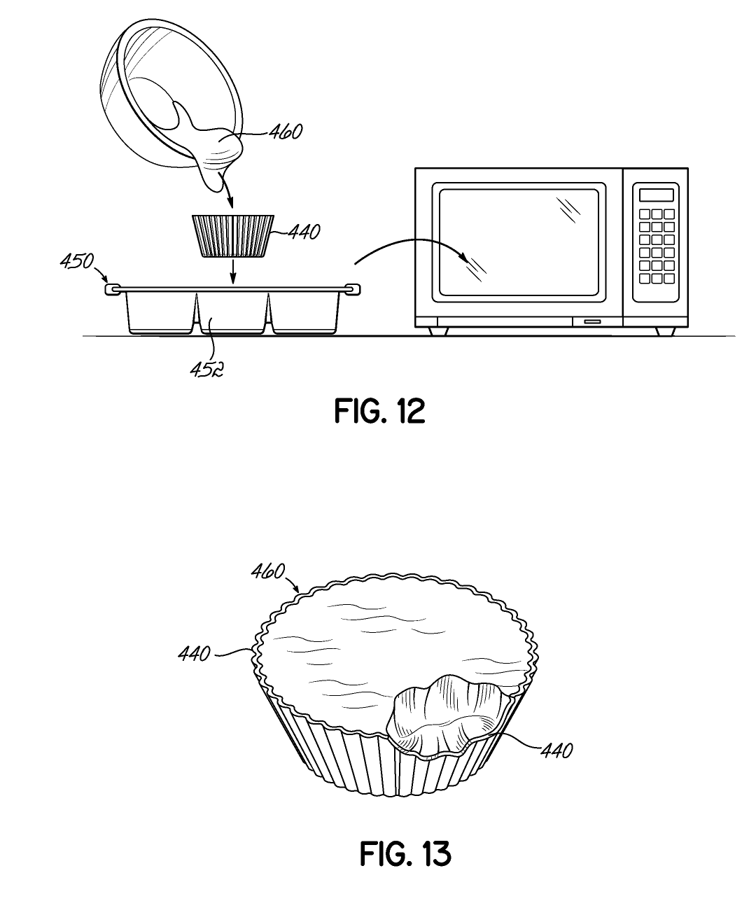

An edible baking liner, manufactured by any of the methods discussed above or by another method known to one of ordinary skill in the art, can be used to aid in the creation of a baked good as illustrated in FIGS. 12 and 13. As shown, edible baking liners 440 in the shape of cups are placed in the depressions 452 of a baking tin 450. Cupcake batter 460 is added to each liner 440, and the baking tin 450 is placed in an oven to be baked. A resulting cupcake 460 can be removed from each depression 452, each of the cupcakes now including a liner 440 that adheres to and is part of the cupcake 460. The cupcake 460 can be eaten with the liner 440.

The edible paper as described may be receptive to a variety of flavorings and food-safe colorings. It is possible to add designs to the paper which will persist through the baking process. For example, it is possible to add words or images to the paper through the use of food-safe colorings which will persist as part of the resulting baked good after the baked good and liner are baked together in accordance with the invention. Additional ingredients added to include flavors, such as confection flavors like chocolate or blueberry, are also contemplated as being within the scope of the invention. Liner flavors may be already present in the baked good or may be introduced only in the liner. Edible liners may be packaged and sold with flavors or designs already included or may be sold along with kits to allow the baker to add flavors or designs during preparation for baking.

The above embodiments are intended to be illustrative and not limiting on the scope of the invention.

What is claimed is:

1. An edible baking liner defining a recess for receiving bakable material, the liner comprising an edible paper;
wherein the edible paper comprises vegetable starch, the vegetable starch having a granular size of more than about 10 μm.

2. The edible baking liner of claim 1, wherein the recess defines a base and a side attached to the base, and wherein the base and side each comprise the edible paper.

3. The edible baking liner of claim 2, wherein the side is pleated.

4. The edible baking liner of claim 2, wherein the liner is shaped from a single sheet of the edible paper such that the base and side form a single integral piece of material.

5. The edible baking liner of claim 1, wherein the edible baking liner suitable to be baked and consumed along with a baked good.

6. The edible baking liner of claim 5, wherein the edible baking liner is of a size and shape suitable to act as the liner for a cupcake prepared in a cupcake tin.

7. The edible baking liner of claim 1, wherein the vegetable starch comprises at least one of potato, corn, cassava, sorghum, wheat, tapioca, arrowroot, or sweet potato starch.

8. The edible baking liner of claim 1, wherein the edible paper is a wafer paper that is potato-based.

9. A process for preparing an edible baking liner, comprising shaping edible paper to define a recess for receiving bakable material;
wherein the edible paper comprises vegetable starch, the vegetable starch having a granular size of more than about 10 μm.

10. The process of claim 9, wherein shaping the edible paper comprises the steps of:
forming a base from the edible paper, and
forming a side attached to the base, the side comprising the edible paper;

11. The process of claim 10,
wherein shaping the edible paper further comprises the steps of:
obtaining a substantially flat sheet of the edible paper, and
pressing the sheet into the shape of the liner; and
wherein the step of forming the side further comprises folding the first portion relative to a second portion adjacent the first portion.

12. The process of claim 9, wherein the process forms an edible baking liner of a size and shape suitable to be baked and consumed along with a baked good.

13. The process of claim 12, wherein the process forms an edible baking liner of a size and shape suitable to act as the liner for a cupcake prepared in a cupcake tin.

14. The process of claim 9, wherein the vegetable starch comprises at least one of potato, corn, cassava, sorghum, wheat, tapioca, arrowroot, or sweet potato starch.

15. The process of claim 9, wherein the edible paper is a wafer paper that is potato-based.

16. A method for preparing a baked good comprising:
lining a baking receptacle with edible paper, the paper comprising a vegetable starch having an average granular size of more than about 10 μm;
placing baking ingredients in the baking receptacle with the edible paper; and
baking the ingredients and the paper in order to produce a baked good that is suitable to be consumed without removing the edible paper.

17. The process of claim 16, wherein the vegetable starch comprises at least one of potato, corn, cassava, sorghum, wheat, tapioca, arrowroot, or sweet potato starch.

18. The process of claim 16, wherein the edible paper is a wafer paper that is potato-based.
